(19) United States
(12) Patent Application Publication
(10) Pub. No.: US 2003/0105702 A1
(43) Pub. Date: Jun. 5, 2003

(54) System and method for assessing the degree of diversification of a portfolio of assets

(76) Inventors: Austin M. Long III, Austin, TX (US); Craig J. Nickels, Marble Falls, TX (US)

Correspondence Address: Andrew G. DiNovo, VINSON & ELKINS LLP, 2300 First City Tower, 1001 Fannin, Houston, TX, 77002-6760, US

(21) Appl. No.: 10/234,506

(22) Filed: Sep. 4, 2002

Related U.S. Application Data
(60) Provisional application No. 60/317,406, filed on Sep. 5, 2001.

(51) Int. Cl. G06F 17/60

(52) U.S. Cl. 705/36

(57) ABSTRACT

A system and method is disclosed for assessing the degree of diversification of a portfolio of assets by determining the average covariance and the average correlation coefficient of the assets within the investment portfolio using successive incremental random sampling (“SIRS”).

### COPYRIGHT NOTICE

A portion of the disclosure of this patent document contains material which is subject to copyright protection. The copyright owner has no objection to the reproduction by anyone of the patent document, or of the patent disclosure as it appears in the Patent and Trademark Office patent files or records, but otherwise reserves all copyrights whatsoever.

### I. FIELD OF THE INVENTION

The invention relates to a system and method for assessing the degree of diversification of a portfolio of assets by determining the average covariance and the average correlation coefficient of the assets within the investment portfolio using successive incremental random sampling (“SIRS”).

### II. BACKGROUND OF THE INVENTION

Persons undertaking portfolio management and decision-making frequently encounter the issue whether the portfolio under management or consideration is sufficiently diversified. A diverse portfolio carries with it less risk and volatility than a non-diverse portfolio. Conversely, a portfolio may be overly diverse, insofar as diversification typically carries with it certain costs, including management and administrative costs.

In 1970, Lawrence Fisher and James Lorie published the results of an experiment¹, designed to empirically test the predictiveness of the following equation², in which σ_{P}² represents the square of the standard deviation or risk of the portfolio, wᵢ² represents the square of the weight for an investment, and σᵢ² represents the standard deviation for an investment in the portfolio:

$${σ}_{P}^{2} = {\sum }_{i = 1}^{n} {w}_{i}^{2} {σ}_{i}^{2} + {\sum }_{j = 1 \neq i}^{n} {\sum }_{i = 1}^{n} {w}_{i} {w}_{j} Cov ( {r}_{i} , {r}_{j} ) \qquad ( 1 )$$

If the investments or positions in the portfolio are all equal in size so that each is 1/n of the total (as they were in the Fisher and Lorie experiment), this equation can be expressed as:

$${σ}_{P}^{2} = \frac{1}{n} {\sum }_{i = 1}^{n} \frac{1}{n} {σ}_{i}^{2} + {\sum }_{j = 1 \neq i}^{n} {\sum }_{i = 1}^{n} \frac{1}{{n}^{2}} Cov ( {r}_{i} , {r}_{j} ) \qquad ( 2 )$$

The average variance of the individual assets is thus:

$$\overline{{σ}_{P}^{2}} = \frac{1}{n} {\sum }_{i = 1}^{n} {σ}_{i}^{2} \qquad ( 3 )$$

, and the average covariance among pairs of the assets is:

$$\overline{Cov} = \frac{1}{n ( n - 1 )} {\sum }_{j = 1 \neq i}^{n} {\sum }_{i = 1}^{n} {Cov}_{j} ( {r}_{i} , {r}_{j} ) \qquad ( 4 )$$

; therefore, portfolio variance can be expressed as:

$${σ}_{P}^{2} = \frac{1}{n} {\overline{σ}}^{2} + \frac{n - 1}{n} \overline{Cov} \qquad ( 5 )$$

As a shorthand means of expressing the relationship between portfolio standard deviation and the standard deviation of the components of the portfolio, this is frequently stated as:

$${σ}_{P} = \frac{\sum {σ}_{s}}{\sqrt{N}} \qquad ( 6 )$$

In their experiment, Fisher and Lorie randomly selected thousands of single stocks from a universe consisting of all publicly traded equities, then thousands of equally weighted combinations of two stocks, thousands of equally weighted combinations of three stocks and so on through a portfolio of thirty equally weighted stocks. The results of the experiment empirically verified that diversification reduces specific risk in such a way as to drive the portfolio towards systematic risk, i.e. the level of risk present in the market as a whole. Fitting a trend line to the Fisher and Lorie data, the tendency of an increased number of investments to decrease portfolio standard deviation becomes clear³.

Thus, the Fisher and Lorie experiments demonstrate that portfolio diversification leads to a reduced degree of risk. What they do not do is quantify the degree of diversification of a particular portfolio in a particular market so as to facilitate decision-making with respect to expanding or reducing diversification. A need has therefore arisen for a more efficient and precise system and method for assessing the degree of diversification of a portfolio of assets, public or private, within a particular market.

### BRIEF DESCRIPTION OF THE DRAWINGS

References are made to the following description taken in connection with the accompanying drawings, in which:

FIG. 1 is a graph of selected Fisher/Lorie experiment results against portfolio standard deviation;

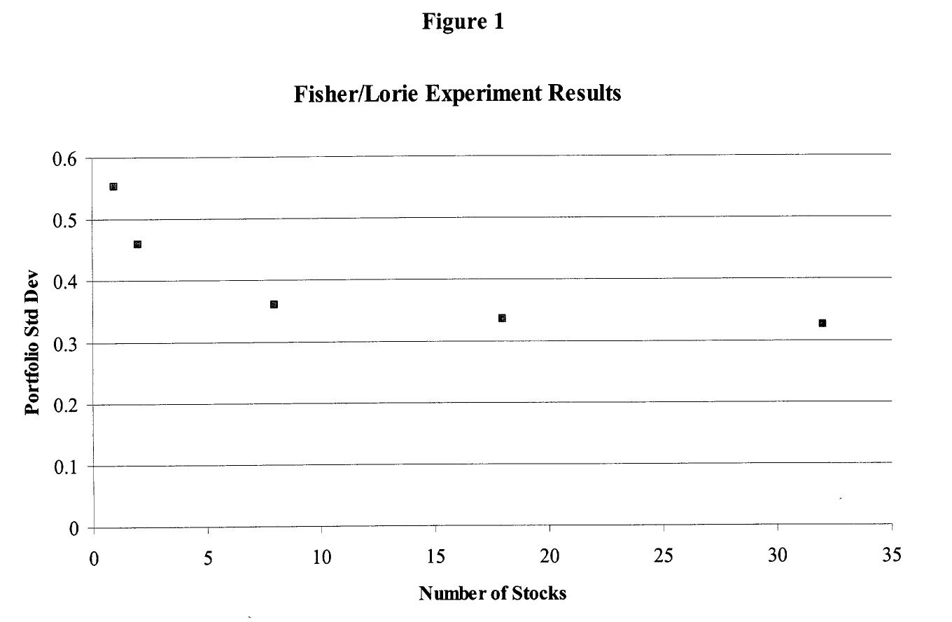

FIG. 2 is the graph of FIG. 1 further including a trend line depicting the relationship between the number of investments versus portfolio standard deviation;

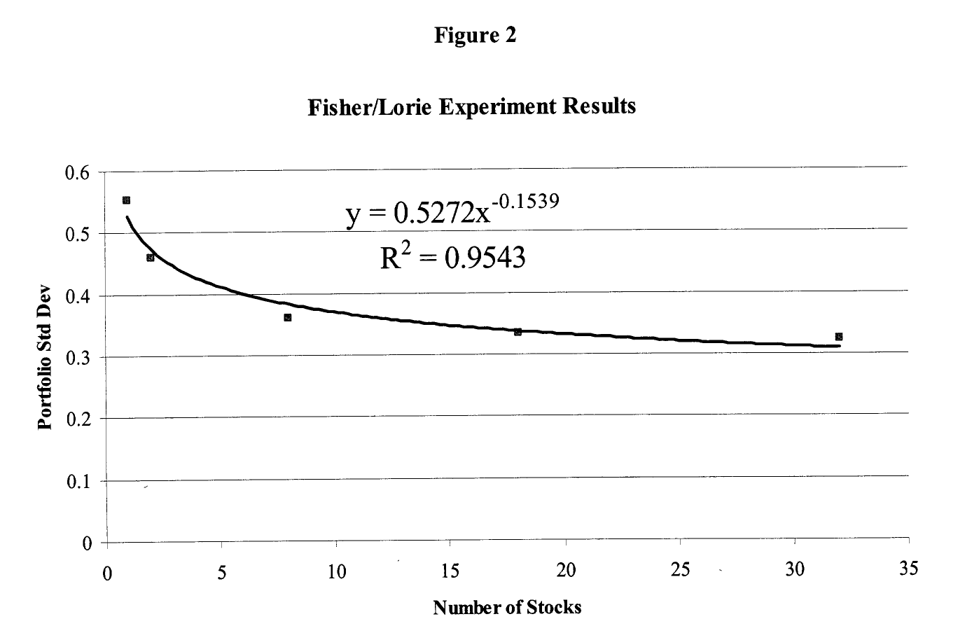

FIG. 3 is the graph of FIG. 2 further indicating a graph of Fisher/Lorie experiment results assuming that the average covariance is zero;

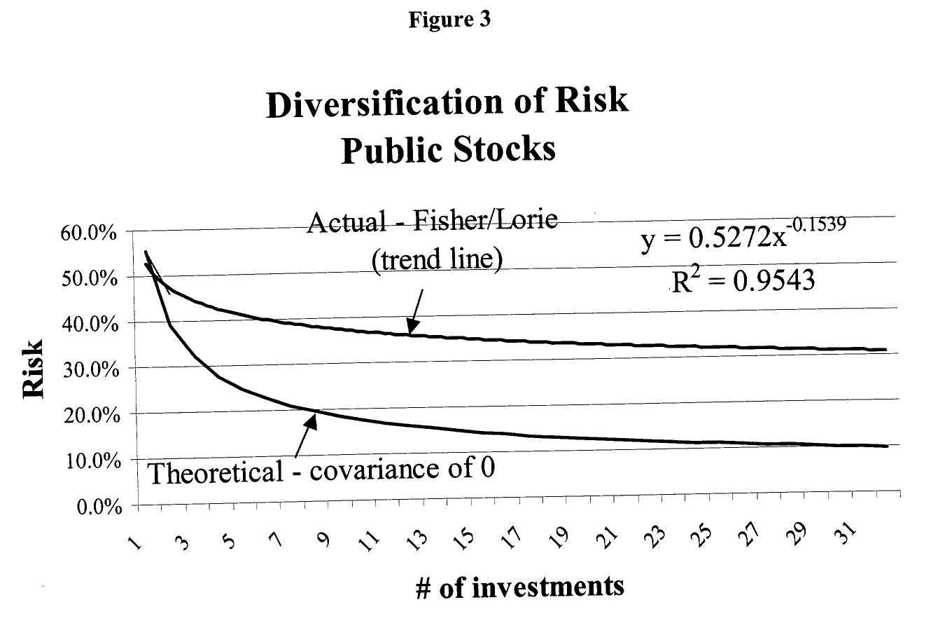

FIG. 4 is a graph of the relationship between IRR standard deviation and the number of investments in an actual portfolio of private investments;

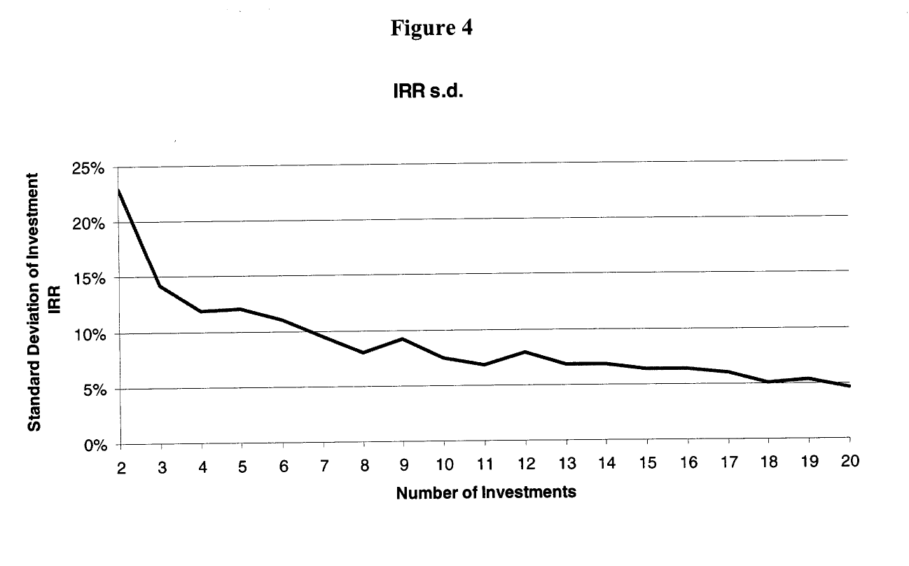

FIG. 5 is a graph of times money earned (“TME”) standard deviation and the number of investments in an actual portfolio of private investments;

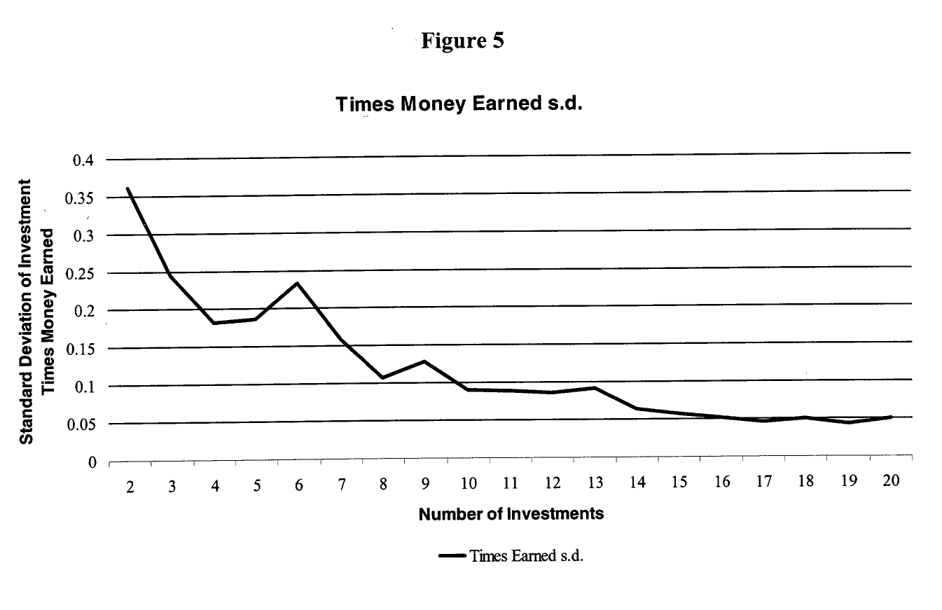

FIG. 6 is the graph of FIG. 4, superimposed with data showing the theoretical maximum decrease in variability associated with IRR;

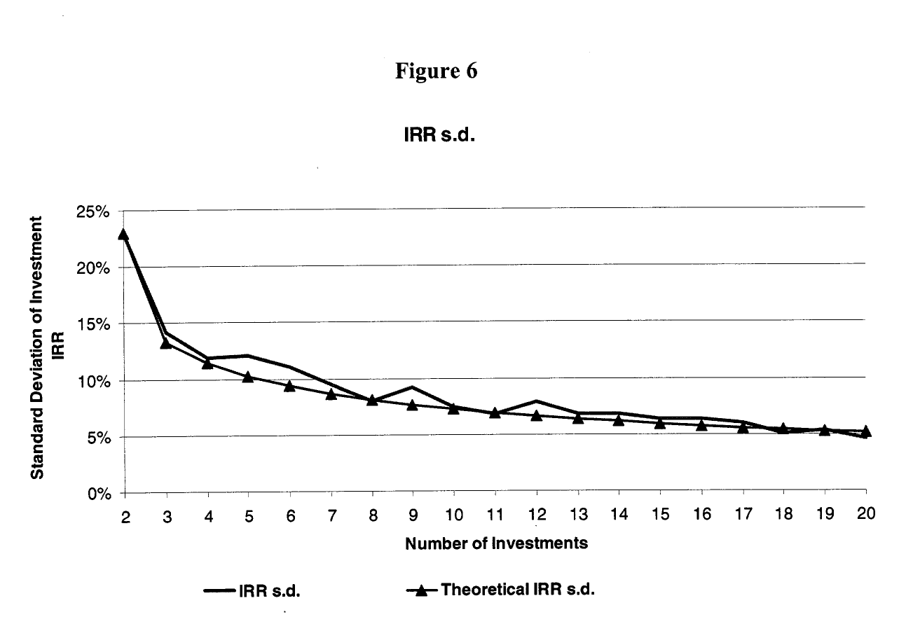

FIG. 7 is the graph of FIG. 4, superimposed with data showing the theoretical maximum decrease in variability associated with TME;

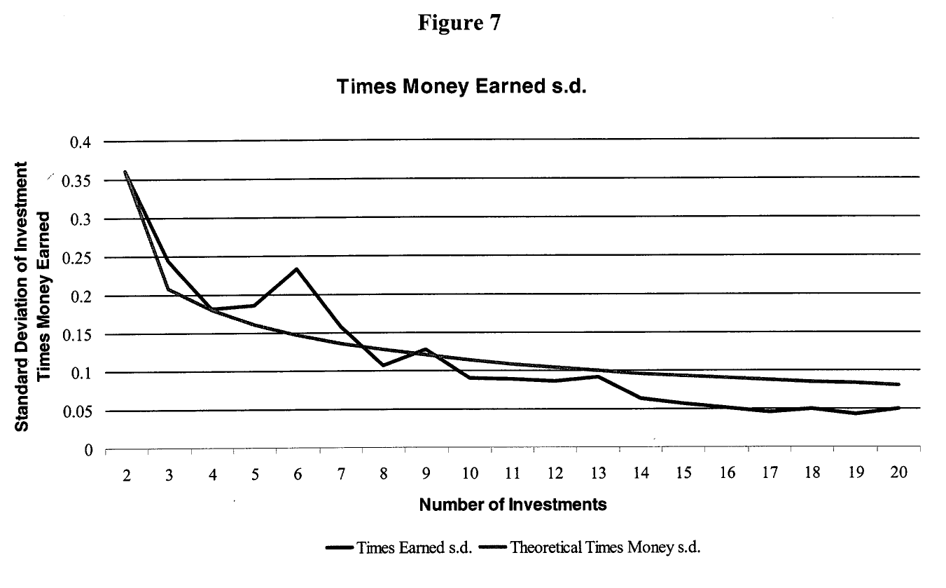

FIG. 8 is a graph of number of investments versus standard deviation of investment IRR in an atual private investment portfolio, further depicting the 68% probability 1σ range above and below the trend line of actual decrease in variability associated with IRR and including the theoretical maximum decrease in variability; and

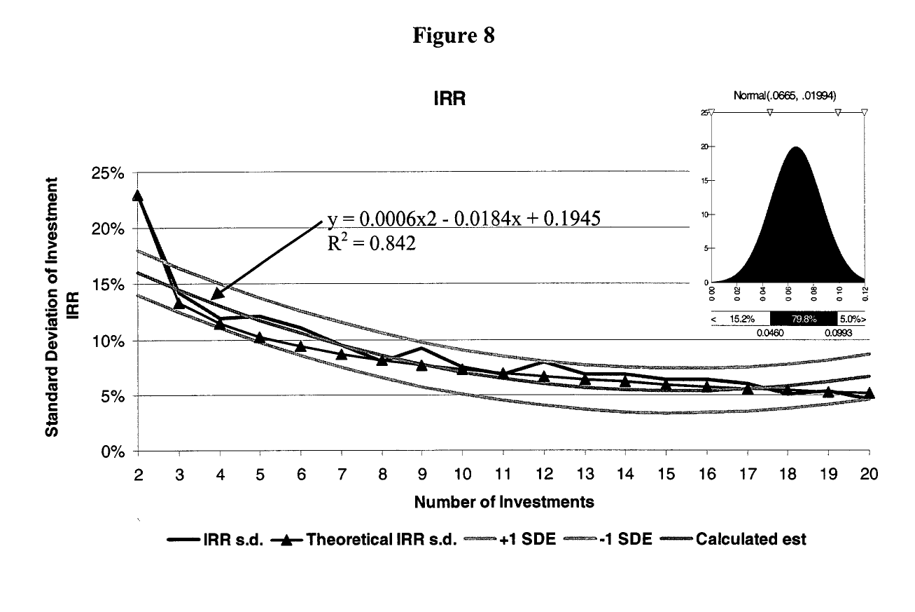

FIG. 9 is a graph of number-of investments versus standard deviation of investment TME in an atual private investment portfolio, further depicting the 68% probability 1σ range above and below the trend line of actual decrease in variability associated with TME and including the theoretical maximum decrease in variability.

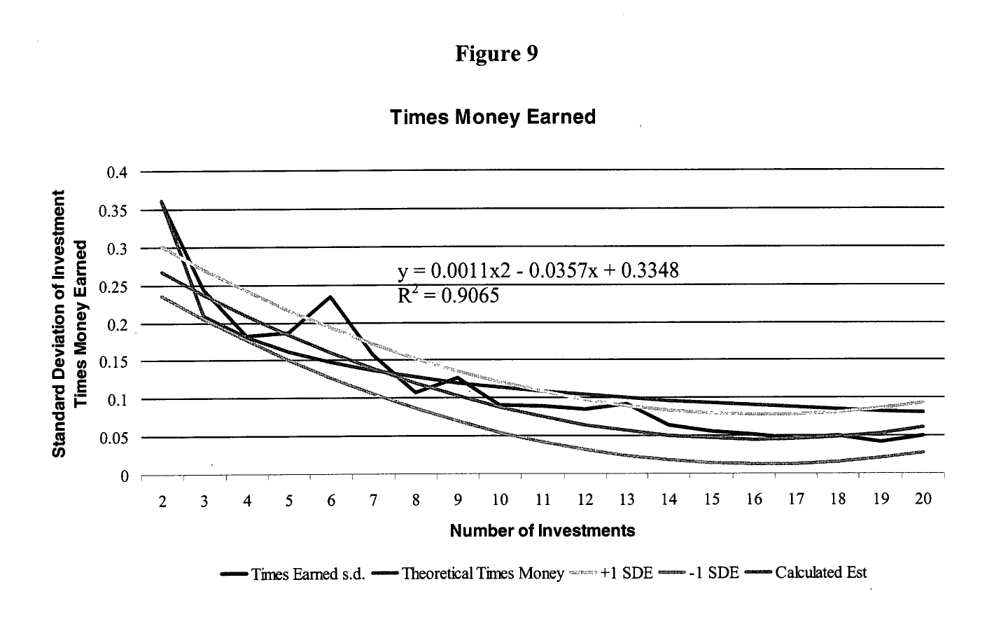

### DETAILED DESCRIPTION OF A PREFERRED EMBODIMENT

The present invention relates to a system and method for determining the degree of diversification of a target portfolio of assets. As described herein, it is possible to calculate the average internal covariance and the average internal r (i.e., the average coefficient of correlation between pairs of assets) of any given portfolio of assets, given only that the common attribute being assessed can be described as random, by (1) forecasting the outcome of the Fisher and Lorie experiment as performed on such portfolio assuming an average covariance of zero; and (2) performing successive incremental random sampling (SIRS) on the portfolio. The SIRS technique consists of random sampling of portfolio assets in incrementally increasing sample sizes, beginning with 1 and extending through, say, 32. Subtracting (1) from (2) yields the difference attributable to average covariance and knowledge of the portfolio standard deviation that makes it possible to calculate the average r.

A. Overview

Portfolios of assets with high average internal covariance and high average internal r will be riskier (in terms of either periodic volatility or the certainty of the portfolio outcome of the characteristic being assessed) than portfolios composed of the same types of assets that have a lower portfolio average internal covariance and lower portfolio average internal r. This is true even though both portfolios have the same return. Put another way, the Sharpe ratio (i.e., the return per degree of risk) of a portfolio of assets with high average internal covariance and high average internal r will be lower than a portfolio of the same assets with low average internal covariance and low average internal r. Minimizing the average covariance of a portfolio thus maximizes its Sharpe ratio.

Securities analysts and other managers responsible for minimizing the risk and maximizing the output of a portfolio of risky assets can therefore use the disclosed method to determine the average internal covariance and the average internal r as a test of the relative effectiveness of diversification in minimizing the specific risk (whether measured in terms of outcome or in terms of periodic volatility) of the assets in a portfolio and thus maximizing its Sharpe ratio (i.e., its efficiency). Analysts and managers can also use the disclosed method to determine the number of assets required to achieve effective diversification of specific risk, and thus maximization of the Sharpe ratio, in a particular portfolio.

The method of the present invention may be implemented on a prior art computer system running software following the process described herein.

B. Method Applied to Public Market Equities

Below, the disclosed method is applied to the Fisher and Lorie experiment itself to determine the average covariance and the average correlation coefficient of the stocks comprising the universe of quoted equities sampled in their experiment.

A first step is determining the actual decrease in variability of the portfolio as a function of the number of assets in it by successive incremental random sampling (“SIRS”) of the portfolio. The SIRS technique consists of random sampling of portfolio assets in incrementally increasing sample sizes, beginning with 1 and extending through, say, 32. In a preferred embodiment, the SIRS is undertaken without replacement. The result for a portfolio of assets consisting of public stocks is shown in the two graphs on the previous page.

Second, the result of the Fisher and Lorie experiment is forecast assuming that the average covariance shown in equation (5) above is zero. This is equivalent to using equation (6) above to calculate a curve containing the performance of a theoretically perfectly uncorrelated portfolio of assets (shown in the graph below superimposed on the trend line of the original experiment).

Third, each point of the two curves is compared to determine the implied average covariance of the assets in the portfolio. Thus, the portfolio variance:

$${σ}_{P}^{2} = \frac{1}{n} {\overline{σ}}^{2} + \frac{n - 1}{n} \overline{Cov}$$

less the theoretical variance with an average covariance of zero:

$$- {σ}_{T}^{2} = - \frac{1}{n} {\overline{σ}}^{2}$$

yields the average covariance in terms of the expected change in portfolio variance:

$${Δσ}_{P - T}^{2} \frac{n}{n - 1} = \overline{Cov} \qquad ( 7 )$$

Fourth, and finally, we use the average covariance and average variance of the assets in the portfolio to calculate the average correlation coefficient:

$${\overline{r σ}}^{2} = \overline{Cov} ; = \overline{r} = \frac{\overline{Cov}}{\overline{{σ}^{2}}}$$

Thus, using equations (7) and (8) the outcome of the Fisher and Lorie experiment in terms of the disclosed method is that the average covariance and average correlation coefficient of the stocks in the sampled universe was as follows, for n=32:

$${Δσ}_{P - T}^{2} \frac{n}{n - 1} = {\overline{Cov} \\ ( .325 )}^{2} - {( .0979343 )}^{2} \frac{32}{31} = \overline{Cov}$$

$$.0991317 = \overline{Cov}$$

$$\overline{r} = \frac{\overline{Cov}}{\overline{{σ}^{2}}}$$

$$\overline{r} = \frac{.0991317}{{( .554 )}^{2}}$$

$$\overline{r} = .323$$

Thus, on average, 32.3% of the movement of a particular asset in the portfolio is explained by the movement of other assets in the portfolio. This is the public market average coefficient of correlation in 1970, when Fisher and Lorie performed their experiment.

C. Method Applied to Private Market Equities

It is extremely important to note three differences between the Fisher and Lorie experiment, which was performed on public market equities as outlined above, and applying the SIRS method to a portfolio of private market equities (or some other aggregation of assets) as shown in the section below.

First, the Fisher and Lorie portfolio positions were all equally weighted, while the private market equity positions in the example below are randomly weighted since they are drawn at random from a population of varying weights.

Second, the Fisher and Lorie experiment decreased the standard deviation of the portfolio's price movements (each asset of which possesses an individual standard deviation), while applying the SIRS method to a private market portfolio decreases the standard deviation of both the IRR and the times money earned on the portfolio (which have sample standard deviations, not individual standard deviations). In other words, Fisher and Lorie measured the impact of diversification on price movements, while the example below applies the SIRS method to a private market portfolio to measure the impact of diversification on investment outcomes.

Third, the SIRS method used in the experiment below sampled only a single private market portfolio, which was self-selected, while Fisher and Lorie sampled the entire universe of public stocks available for investment.

Taking all these differences into account, however, the disclosed method enables a private market portfolio manager to quantify the decrease the variability of outcome (and therefore the risk of a bad outcome) of a portfolio as a function of the number of assets in the portfolio. The same can be said for minimizing the variability of outcome for any other portfolio of assets, including the physical production of a portfolio of oil & gas properties or any other portfolio outcome that can be described probabilistically.

D. A Private Market Portfolio Example

The disclosed method applies to any portfolio of assets with random characteristics, including the returns of private market portfolios, portfolios of oil and gas wells (whether examining physical production or dollars of revenue), etc. For example, we used the Fisher and Lorie sampling method to analyze the investment IRR⁴ of the assets in a private market portfolio.

As step one, we employed the SIRS method to sample the private investment portfolio to determine the decrease in variability of IRR as a function of the number of investments sampled.

In a first step, one can use the same method to produce the following curve expressed as times money earned on the investment (TME).

Second, determine the theoretical maximum decrease in variability associated with both IRR and TME (shown here superimposed over the results of step one). Note that in the TME graph, the actual standard deviation is less than the theoretical. This means that the average covariance of TME is negative.

Third, we calculate the implied covariance using Equation (7), using n=20, for IRR and TME:

$${Δσ}^{2} \frac{n}{n - 1} = \overline{Cov}$$

Fourth, we calculate the average correlation coefficient using the average covariance determined in the third step and the average variance for both IRR and TME:

$$\overline{r} = \frac{\overline{Cov}}{\overline{{σ}^{2}}}$$

The following tables combine steps three and four:

| | IRR | | | | | |
|---|---|---|---|---|---|---|
| | 1 | 2 | 3 | 4 | 5 | 6 |
| | Sigma | Variance | n/(n-1) | Avg Cov | Mean Var | Avg r |
| Actual | 4.586% | 0.0021028 | | | | |
| Theoretical | 0.0665 | 0.0044223 | | | | |
| | | −0.002319 | 1.0526 | −0.0024 | 0.052761 | −0.0463 |
| | TME | | | | | |
| | 5.047% | 0.0025473 | | | | |
| | 0.0608 | 0.0036966 | | | | |
| | | −0.001149 | 1.05263 | −0.00121 | 0.1299645 | −0.0093 |

As this example illustrates, it is possible for a private market portfolio to have a much lower average internal correlation than a randomly selected portfolio of public stocks.

It is also important to note that the standard error of the trend line of the sampled figure (shown in the graphs below as light blue lines on either side of the green trend line) can indicate, as it does in this case, that the outcome may not be statistically significant, since there is a 15.2% probability that the Δσ² could be zero (and therefore the coefficient of correlation could be zero) for the IRR computation. The same is true for the computation of TME.

While the invention has been described in the context of a preferred embodiment, it will be apparent to those skilled in the art that the present invention may be modified in numerous ways and may assume many embodiments other than that specifically set out and described above. Accordingly, it is intended by the appended claims to cover all modifications of the invention that fall within the true scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A process for determining a degree of diversification of a portfolio having assets comprising:
determining an actual variance of said portfolio as a function of the number of said assets;
forecasting a result of a Fisher and Lorie experiment assuming that an average covariance is zero;
comparing said actual decrease in variability to said result to determine an implied average covariance of said assets; and
calculating an average correlation coefficient using said average covariance and said variance of said assets in the portfolio.

2. The process of claim 1, wherein said determining step is accomplished by successive incremental random sampling of said portfolio.

3. The process of claim 2, wherein said successive incremental random sampling is done without replacement.

4. The process of claim 1, wherein said average covariance is expressed by the following equation:
$${σ}_{P}^{2} = \frac{1}{n} {\overline{σ}}^{2} + \frac{n - 1}{n} \overline{Cov} .$$

5. The process of claim 1, wherein said implied average covariance of the assets is expressed by the following equation:
$${Δσ}_{P - T}^{2} \frac{n}{n - 1} = \overline{Cov} .$$

6. The process of claim 1, wherein said average correlation coefficient is expressed by the following equation:
$${\overline{r σ}}^{2} = \overline{Cov} ; \overline{r} = \frac{\overline{Cov}}{\overline{{σ}^{2}}}$$

7. A software program for determining the degree of diversification of a portfolio having assets comprising:
means for determining a variance of said portfolio as a function of the number of said assets;
means for forecasting a result of a Fisher and Lorie experiment assuming that an average covariance is zero;
means for comparing said actual decrease in variability to said result to determine an implied average covariance of the assets in the portfolio; and
means for calculating the average correlation coefficient using said average covariance and variance of said assets.

8. The software of claim 7, wherein said means for determining uses successive incremental random sampling of said portfolio.

9. The software of claim 7, wherein said successive incremental random sampling is done without replacement.

10. The software of claim 7, wherein said average covariance is expressed by the following equation:
$${σ}_{P}^{2} = \frac{1}{n} {\overline{σ}}^{2} + \frac{n - 1}{n} \overline{Cov} .$$

11. The software of claim 7, wherein said implied average covariance of said assets is expressed by the following equation:
$${Δσ}_{P - T}^{2} \frac{n}{n - 1} = \overline{Cov} .$$

12. The software of claim 7, wherein said average correlation coefficient is expressed by the following equation:
$${\overline{r σ}}^{2} = \overline{Cov} ; \overline{r} = \frac{\overline{Cov}}{\overline{{σ}^{2}}}$$

13. A computerized system for monitoring the degree of diversification of a portfolio of assets comprising:
a computer system comprising a display, a processor and an input device;
means for determining the variance of said portfolio as a function of the number of said assets;
means for forecasting the result of a Fisher and Lorie experiment assuming that an average covariance is zero;
means for comparing said actual decrease in variability to said result to determine an implied average covariance of the assets in the portfolio; and
means for calculating the average correlation coefficient using said average covariance and variance of said assets.

14. The system of claim 13, wherein said means for determining uses successive incremental random sampling of said portfolio.

15. The system of claim 13, wherein said successive incremental random sampling is done without replacement.

16. The system of claim 13, wherein said average covariance is expressed by the following equation:
$${σ}_{P}^{2} = \frac{1}{n} {\overline{σ}}^{2} + \frac{n - 1}{n} \overline{Cov} .$$

17. The system of claim 13, wherein said implied average covariance of the assets is expressed by the following equation:
$${Δσ}_{P - T}^{2} \frac{n}{n - 1} = \overline{Cov} .$$

18. The system of claim 13, wherein said average correlation coefficient is expressed by the following equation:
$${\overline{r σ}}^{2} = \overline{Cov} ; \overline{r} = \frac{\overline{Cov}}{\overline{{σ}^{2}}}$$
